(19) United States
(12) Patent Application Publication
(10) Pub. No.: US 2003/0126372 A1
(43) Pub. Date: Jul. 3, 2003

(54) Cache coherency arrangement to enhance inbound bandwidth

(76) Inventor: Tony S. Rand, Tacoma, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/039,034

(22) Filed: Jan. 2, 2002

(51) Int. Cl. G06F 12/00; G06F 12/14

(52) U.S. Cl. 711/141; 711/138; 711/137

(57) ABSTRACT

A cache coherency arrangement with support for pre-fetching ownership, to enhance inbound bandwidth for single leaf and multiple leaf, input-output interfaces, with shared memory space is disclosed. Embodiments comprise ownership stealing and address matching to reduce transaction latency and prevent deadlock and/or starvation. Several embodiments may also comprise cache to reduce transaction latency and logic to populate the cache.

### FIELD OF INVENTION

The present invention is in the field of cache coherency. More particularly, the present invention provides a method, apparatus, system, and machine-readable medium for cache coherency with support for pre-fetch ownership, to enhance inbound bandwidth for single leaf and multiple leaf, input-output interfaces, with shared memory space.

### BACKGROUND

Coherent transactions limit the bandwidth for transactions from a peripheral input-output (I/O) bus in processor-based systems such as desktop computers, laptop computers and servers. Processor-based systems typically have a host bus that couples a processor and main memory to ports for I/O devices. The I/O devices, such as Ethernet cards, couple to the host bus through an I/O controller or bridge via a bus such as a peripheral component interconnect (PCI) bus. The I/O bus has ordering rules that govern the order of handling of transactions so an I/O device may count on the ordering when issuing transactions. When the I/O devices may count on the ordering of transactions, I/O devices may issue transactions that would otherwise cause unpredictable results. For example, after an I/O device issues a read transaction for a memory line and subsequently issues a write transaction for the memory line, the I/O device expects the read completion to return the data prior to the new data being written. However, the host bus may be an unordered domain that does not guaranty that transactions are carried out in the order received from the PCI bus. In these situations, the I/O controller governs the order of transactions.

The I/O controller places the transactions in an ordering queue in the order received to govern the order of inbound transactions from an I/O bus, and waits to transmit the inbound transaction across the unordered interface until the ordering rules corresponding to each transaction are satisfied. However, issuing transactions one at a time as the transaction satisfies ordering rules limits the latency of a transaction to a nominal latency equal to the nominal snoop latency for the system. In addition, when multiple I/O devices transmit coherent transactions to the I/O controller, transactions unnecessarily wait in the ordering queue for coherent transactions with unrelated ordering requirements. For example, in conventional systems, a read transaction received subsequent to a write transaction for the same address will wait for the write transaction to issue even though the read transaction may have issued from a different I/O device, subjecting the read transaction to ordering rules independent from the ordering rules of the write transaction. As a result, the latency of the snoop request, or ownership request, for the write transaction adds to the latency of the read transaction and when a conflict exists with the issuance of the ownership request for the write transaction, the latency of the write transaction, as well as the read transaction, will be longer than the nominal snoop latency for the system.

I/O devices continue to demand increasing bandwidth, increasing the amount of time transactions remain in an ordering queue. For example, in conventional products, the number of delays resulting from a foreseeable read transaction that waits to access a memory line across the unordered interface and a read transaction that waits for a write transaction to satisfy ordering requirements when the write transaction will write to a different memory line, can escalate in proportion with bandwidth.

### BRIEF FIGURE DESCRIPTIONS

In the accompanying drawings, like references may indicate similar elements:

FIG. 1 depicts an embodiment of a system to transact between an ordered and an unordered interface with a processor coupled with an I/O hub.

FIG. 2 depicts an embodiment of an apparatus with an address queue, read cache, and read bypass queue to enhance inbound bandwidth.

FIG. 3 depicts a flow chart of an embodiment to enhance inbound bandwidth.

FIG. 4 depicts an embodiment of a machine-readable medium comprising instructions to enhance inbound bandwidth.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments. The variations of embodiments anticipated for the present invention are too numerous to discuss individually so the detailed descriptions below are designed to make such embodiments obvious to a person of ordinary skill in the art.

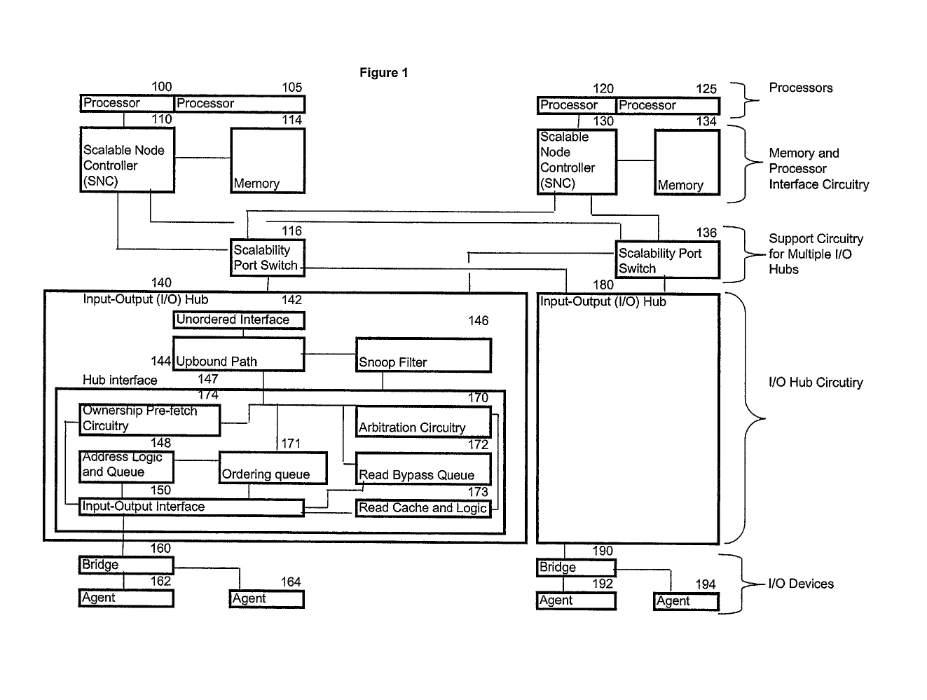

Referring now to FIG. 1, there is shown an embodiment of a system to transact between an ordered and an unordered interface. The embodiment may comprise processors such as processors 100, 105, 120, and 125; processor interface circuitry, such as scalable node controllers 110 and 130; memory 114 and 134; I/O hub circuitry, such as I/O hub 140 and I/O hub 180; and I/O devices, such as bridges 160 and 190. In embodiments that may comprise more than one I/O hub, such as I/O hub 140 and I/O hub 180, support circuitry may couple the processor interface circuitry with the multiple hubs to facilitate transactions between I/O hubs 140 and 180 and processors 100, 105, 120, and 125.

Scalable node controllers 110 and 130 may couple with processors 100 and 105, and 120 and 125, respectively, to apportion tasks between the processors 100, 105, 120, and 125. In some of these embodiments, scalable node controller 110 may apportion processing requests between processor 100 and processor 105, as well as between processors 100 and 105 and processors 120 and 125, for instance, based upon the type of processing request and/or the backlog of processing requests for the processors 100 and 105 and processors 120 and 125.

In several embodiments, scalable node controller 110 may also coordinate access to memory 114 between the processors, 100 and 105, and the I/O hubs, 140 and 180. The support circuitry for multiple I/O hubs, such as scalability port switches 116 and 136, may direct traffic to scalable node controllers 110 and 130 based upon a backlog of transactions. In addition, scalability port switches 116 and 136 may direct transactions from scalable node controllers 110 and 130 to I/O hubs 140 and 180 based upon destination addresses for the transactions. In many embodiments, memory 114 and memory 134 may share entries, or maintain copies of the same data. In several embodiments, memory 114 and memory 134 may comprise an entry that may not be shared so a write transaction may be forwarded to either memory 114 or memory 134.

I/O hubs 140 and 180 may operate in a similar manner to bridge transactions between an ordered domain and an unordered domain by routing traffic between I/O devices and scalability ports. In some embodiments, the I/O hubs 140 and 180 may provide peer-to-peer communication between I/O interfaces. In particular, I/O hub 140 may comprise unordered interface 142, upbound path 144, snoop filter 146, and a hub interface 147. The hub interface 147 may comprise arbitration circuitry 170, ordering queue 171, read bypass queue 172, ownership pre-fetch circuitry 174, address logic and queue 148, read cache and logic 173, and I/O interface 150.

Unordered interface 142 may facilitate communication between I/O hub 140 and a scalable node controller such as 110 and 130 with circuitry for a scalability port protocol layer, a scalability port link layer, and a scalability port physical layer. In some embodiments, unordered interface 142 may comprise simultaneous bi-directional signaling. Unordered interface 142 may couple to scalability port switches 116 and 136 to transmit transactions between scalability node controllers 110 and 130 and agents 162, and 164. Transactions between unordered interface 142 and scalability node controllers 110 and 130 may transmit in no particular order or in an order based upon the availability of resources or the ability for a target to complete a transaction. The transmission order may not be based upon, for instance, a particular transaction order according to ordering rules of an I/O interface, such as a PCI bus. For example, when agent 162 may initiate a transaction to write data to a memory line, agent 162 may transmit four packets to accomplish the write. Bridge 160 may receive the four packets in order and forward the packets in order to I/O interface 150. Ordering queue 171 may maintain the order of the four packets to forward to the unordered interface 142 via the upbound path 144. Scalability port switch 116 may receive the packets from unordered interface 142 and transmit the packets to memory 114 and memory 134.

Upbound path 144 may comprise a path for hub interface 147 to issue transactions to the unordered interface 142 and to snoop filter 146. For example, upbound path 144 may carry inbound coherent requests to unordered interface 142, as well as ownership requests and read cache entry invalidations from ownership pre-fetch circuitry 174 and read cache and logic 173, respectively, to snoop filter 146. In many embodiments, upbound path 144 may comprise a pending transaction buffer to store a pending transaction on the unordered interface 142 until a scalability port switch 116 or 136 may retrieve or may be available to receive the pending transaction.

Further, when an I/O hub such as I/O hub 140 may couple more than one transaction queue, such as ordering queue 171 and read bypass queue 172, to scalability port switches 116 and 136, hub interface 147 may comprise arbitration circuitry 170 to grant access to upbound path 144. In many embodiments, the arbitration circuitry 170 may provide substantially equivalent access to the unordered interface 142. In other embodiments, the arbitration circuitry 170 may arbitrate between the ordering queue 171 and the read bypass queue 172 based upon a priority associated with, or an agent associated with, an enqueued transaction.

Snoop filter 146 may issue ownership requests on behalf of transactions in ordering queue 171, return ownership completions, monitor pending transactions on unordered interface 142, and respond to downbound snoop requests from the unordered interface 142 or from a peer hub interface. In addition, snoop filter 146 may perform conflict checks between snoop requests, ownership requests, and ownerships of memory lines in memory 114 or memory 134. For example, a write transaction waiting at ordering queue 171 to write data to memory line one in memory 114 may reach a top of ordering queue 171. After the write transaction for memory line one may reach the top of ordering queue 171, hub interface 147 may request ownership of memory line one for the write transaction via snoop filter 146. Snoop filter 146 may perform a conflict check with the ownership request and determine that the ownership request may conflict with the ownership of memory line one by a pending write transaction on unordered interface 142. Snoop filter 146 may respond to the ownership request by transmitting an invalidation request to hub interface 147.

Subsequently, hub interface 147 may reissue a request for ownership of memory line one for the write transaction and snoop filter 146 may perform a conflict check and determine that no conflict exists with an ownership by the write transaction. Then, snoop filter 146 may transmit a request for ownership to scalable node controller 110 via scalability port switch 116. In response, snoop filter 146 may receive an ownership completion for memory line one and may return the ownership completion to hub interface 147. In many embodiments, when hub interface 147 may receive an ownership completion for a transaction and may modify the coherency state of the transaction to ‘exclusive’. In several of these embodiments, snoop filter 146 may maintain the coherency state of the transaction in a buffer.

Hub interface 147 may maintain a transaction order for transactions received via I/O interface 150 in accordance with ordering rules associated with bridge 160. Hub interface 147 may also determine the coherency state of transactions received via I/O interface 150. For example, hub interface 147 may receive a write transaction from agent 164 via bridge 160 and place the header for the write transaction in ordering queue 171. Substantially simultaneously ownership pre-fetch circuitry 174 may request ownership of the memory line associated the write transaction via snoop filter 146. The ownership request may be referred to as ownership pre-fetching since the write transaction may not satisfy ordering rules associated with I/O interface 150. In alternate embodiments, when the ordering queue 171 is empty and no transactions are pending on the unordered interface 142, the write transaction may bypass ordering queue 171 and transmit to upbound path 144 to transmit across unordered interface 142.

Snoop filter 146 may receive the request for ownership and perform a conflict check. In some instances, snoop filter 146 may determine a conflict with the ownership by the write transaction. Since the coherency state of the write transaction may be pending when received, snoop filter 146 may deny the request for ownership. After the transaction order of the write transaction may satisfy ordering rules, or in some embodiments after the write transaction reaches the top of ordering queue 171, hub interface 147 may reissue a request for ownership. In response to receiving an ownership completion for the write transaction, hub interface 147 may change the coherency state of the write transaction to ‘exclusive’ and then to ‘modified’. In some embodiments, when the transaction may be at the top of ordering queue 171 upon receipt of an ownership completion, hub interface 147 may change the coherency state of the write transaction directly to ‘modified’, making the data of the write transaction globally visible. In several embodiments, hub interface 147 may transmit the transaction header of the write transaction to snoop filter 146 to indicate the change in the coherency state to ‘modified’.

On the other hand, when the hub interface 147 may receive the ownership completion in response to pre-fetching the ownership, hub interface 147 may change the coherency state of the write transaction to ‘exclusive’ and maintain the transaction in ‘exclusive’ state until the write transaction may satisfy the corresponding ordering rules, unless the ownership may be invalidated, or stolen. For example, the ordering rules governing transactions received via bridge 160 from agent 162 may be independent or substantially independent from ordering rules governing transactions received from agent 164. As a result, many embodiments allow a second transaction to steal or invalidate the ownership of the memory line by a first transaction to transmit to upbound path 144 when the ordering of the second transaction is independent or substantially independent from the ordering of the first transaction. Ownership stealing may prevent backup, starvation, deadlock, or stalling of the second transaction or the leaf comprising the second transaction as a result of the first transaction. In many of these embodiments, ownership may be stolen when the first transaction may reside in a different leaf from the second transaction and/or in the same leaf.

In the present embodiment, read bypass queue 172 may provide a substantially independent path to the unordered interface 142 for read transactions that may be independent of ordering rules associated with transactions in ordering queue 171. Read bypass queue 172 may receive read transactions from the I/O interface 150 or may receive transactions from ordering queue 171. As a result, the embodiment may take advantage of the unrelated transaction ordering between the agent 162 and agent 164 or between read and write transactions from agent 162 and/or agent 164. For example, agent 162 may request a read of memory line one of memory 114. Address logic and queue 148 may determine that a transaction, such as a write transaction, associated with memory line one is in the ordering queue 171. Hub interface 147 may forward the read transaction to ordering queue 171 to maintain a transaction order according to an ordering rule associated with agent 162. Afterwards, snoop filter may apply backpressure to read transactions from hub interface 147 until a pending read transaction in the snoop filter 146 may be transmitted across the unordered interface or until the ordering queue 171 may be flushed. The transactions of ordering queue 171 may be processed until the read transaction from agent 162 reaches the top of ordering queue 171. While backpressure may be applied to the read transaction from snoop filter 146, the read transaction may not be forwarded to snoop filter 146. In response, hub interface 147 may forward the read transaction to the bottom of read bypass queue 172. The read transaction may be forwarded to read bypass queue 172 to allow subsequently received write transactions to continue to transmit to the unordered interface 142. In addition, by reaching the top of ordering queue 171, the transaction order of the read transaction may have satisfied the ordering rules associated with agent 162 so the read transaction may proceed in a path independent from the ordering rules associated with ordering queue 171.

Ownership pre-fetch circuitry 174 may pre-fetch ownership of memory contents associated with a memory line after a transaction is received by I/O interface 150 and may prevent ownership from being pre-fetched in response to a signal from or not receiving a signal from address logic and queue 148. For instance, hub interface 147 may receive two write transactions from agent 162 to write data to the same memory line(s). After the first write transaction is received at I/O interface 150, ownership pre-fetch circuitry 174 may initiate a request for ownership of the memory line(s) associated with the first write transaction. Subsequently, I/O interface 150 may receive the second write transaction. Ownership pre-fetch circuitry 174 may receive a signal, or may not receive a signal in some embodiments, to indicate that ownership of the memory line(s) associated with the second write transaction may not be pre-fetched for the second transaction.

Address logic and queue 148 may maintain a list of pending transactions in hub interface 147 and/or I/O hub 140, depending upon the embodiment, and may compare an address of an upbound transaction to the list to determine whether ownership may be pre-fetched for the transaction and/or the upbound transaction may be subject to independent ordering rules from a transaction in the ordering queue 171. In some embodiments, read transactions may comprise more than one address that may subject the read transaction to more than one ordering rule or set of ordering rules. For example, agent 162 may initiate a first write transaction to write to memory line one, a second write transaction to write to memory line one, and a first read transaction to read from memory line one. Then, agent 164 may initiate a second read transaction to read from memory line one. The I/O interface 150 may receive the first write transaction and address logic and queue 148 may determine that no address in an address queue of the address logic and queue 148 may match memory line one and may transmit a signal to ownership pre-fetch circuitry 174 to pre-fetch ownership of memory line one for the first write transaction.

In response to receiving the second write transaction, address logic and queue 148 may determine that the address is owned by the first write transaction, which is ahead of the second write transaction with regards to transaction order, and may transmit a signal to ownership pre-fetch circuitry 174 to indicate that ownership may not or should not be pre-fetched for the second write transaction. The I/O interface 150 may receive the first read transaction and address logic and queue 148 may determine that the first read may follow the first and second write transactions in a transaction order since agent 162 also initiated the first read transaction. Hub interface 147 may forward the first read transaction to the bottom of ordering queue 171. Then, I/O interface 150 may receive the second read transaction. The second read transaction also performs an action on memory line one, but, in the present embodiment, address and queue logic 148 maintains an address associated with pending transactions that comprises the address of the source agent or a hub ID representing one or more source agents, such as agent 162 for the first and second write transactions and the first read transaction. Since the hub ID of the second read transaction may be different from the hub ID's associated with the first and second write transactions and the first read transaction, the second read transaction may advance toward the unordered interface 142 along an independent path, e.g. the read bypass queue 172, bypassing the first and second write transactions and the first read transaction. In other situations, however, read cache and logic 173 may attach cache line invalidation data to the second read transaction and in response to a match between the address associated with the cache line invalidation data and an address of a pending transaction, such as memory line one, the second read transaction may be forwarded to the bottom of the ordering queue 171 rather than the bottom of the read bypass queue 172. In alternative embodiments, address logic and queue 148 may not maintain an address or ID associated with the source agent so determinations for ownership pre-fetching and/or bypassing may be made based upon the memory line(s) associated with a transaction.

Read cache and logic 173 may review a transaction after the transaction may be received by I/O interface 150. In some embodiments, read cache and logic 173 may recognize a read transaction for a memory line, may determine whether the read cache and logic 173 may store a valid cache line comprising a copy of the memory line, and may respond to the read transaction after determining that read cache and logic 173 may store a valid cache line comprising a copy of the memory line. In other situations, read cache and logic 173 may not comprise the valid cache line and, in many embodiments, read cache and logic 173 may then attach cache line invalidation data to the read transaction to clear space to store the data received in response to the read transaction.

The cache line invalidation data may be forwarded to the snoop filter 146 to maintain synchronization between the read cache coherency states and the coherency states stored in the snoop filter 146. The cache line invalidation data may comprise or be associated with an entry in the cache of read cache and logic 173 and the address of the memory line associated with the entry. In many embodiments, the cache line invalidation data may be designed to instruct the snoop filter to invalidate an association between an address in the snoop filter 146 and an entry in the read cache. For example, read cache and logic 173 may store a cache version of memory line one and I/O interface 150 may receive a read transaction for memory line two. When read cache and logic 173 may not comprise a copy of the latest version of memory line two, read cache and logic 173 may clear room in cache for memory line two. In several embodiments, read cache and logic 173 may invalidate the oldest and/or least used data in cache, such as memory line one, to make room for a copy of memory line two. In many of these embodiments, read cache and logic 173 may insert an invalidation request for the copy of memory line one into the header for the read transaction of memory line two. As a result, the data of the read completion for memory line two may be stored over the entry for memory line one. Snoop filter 146 may receive the invalidation request after the read transaction may reach the snoop filter 146 and may return a copy of the data from the read completion to read cache and logic 173. In some embodiments, read cache and logic 173 may further store data of a write transaction, or other memory lines near the memory line subject to the read transaction, into cache in anticipation of a read transaction for the same memory line(s).

In the present embodiment, bridges 160 and 190, couple one or more agents 162, 164, 192, and 194 to the I/O hubs 140 and 180 from an ordered domain such as a peripheral component interconnect (PCI) bus, a universal serial bus (USB), or an infiniband channel. The agents 162, 164, 192, and 194 may transact upbound or peer-to-peer via I/O hubs 140 and 180. In many of these embodiments, agents 162, 164, 192, and 194 may transact with any processor and processors 100, 105, 120, and 125 may transact with any agent.

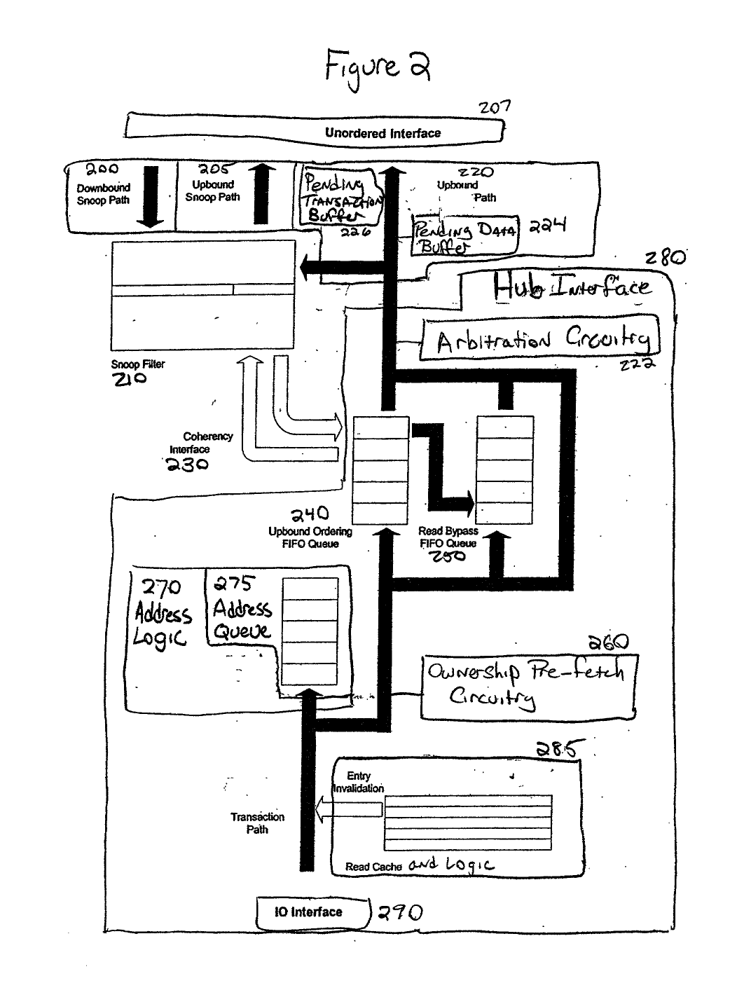

Referring now to FIG. 2, there is shown an embodiment of an apparatus of an I/O hub to maintain ordering for transactions between an ordered domain, I/O interface 290, and unordered domain, unordered interface 207. The embodiment may comprise unordered interface 207, downbound snoop path 200, upbound snoop path 205, snoop filter 210, coherency interface 230, hub interface 280, and upbound path 220. The downbound snoop path 200 may comprise circuitry to transmit a snoop request from the unordered interface 207 down to snoop filter 210. The upbound snoop path 205 may provide a path between snoop filter 210 and a controller on the other side of the unordered interface 207 to facilitate snoop request by snoop filter 210 and/or I/O devices coupled with I/O interface 290. In some embodiments, upbound snoop path 205 may facilitate cache coherency requests. For example, a processor in the unordered domain may comprise cache and snoop filter 210 may request invalidation of a cache line after hub interface 280 may receive a write transaction for memory associated with that cache line.

Snoop filter 210 may comprise conflict circuitry and a buffer. Conflict circuitry may determine conflicts between downbound snoop requests, inbound read transactions, inbound write transactions, and upbound transactions. Further, conflict circuitry may couple with the buffer to store the coherency states and associate the coherency states with entries in the upbound ordering first-in, first-out (FIFO) queue 240.

Coherency interface 230 may relay internal coherency completion and invalidation requests from snoop filter 210 to hub interface 280. These coherency requests may be generated by snoop filter 210 and may be the result of an ownership completion, a downbound snoop request, or an inbound coherent transaction. For example, after snoop filter 210 receives an ownership completion across unordered interface 207, snoop filter 210 may forward the completion across coherency interface 230 to the hub interface 280. The ownership completion may be addressed to the entry in the upbound ordering FIFO queue 240 that has a write transaction header associated with the corresponding ownership request.

Hub interface 280 may receive inbound transactions, such as upbound write and read transactions, and maintain ordering of the upbound transactions in accordance with ordering rules, such as PCI ordering rules and rules associated with coherency and the PCI producer consumer model. Hub interface 280 may comprise arbitration circuitry 222, transaction queues such as upbound ordering FIFO queue 240 and read bypass FIFO queue 250, ownership pre-fetch circuitry 260, address logic 270, address queue 275, read cache and logic 285, and I/O interface 290. Arbitration circuitry 222 may arbitrate access to the upbound path 220 between transaction queues, upbound ordering FIFO queue 240 and read bypass FIFO queue 250. In some embodiments, arbitration circuitry 222 may also arbitrate access between the transaction queues and ownership pre-fetch circuitry 260 to facilitate routing of coherency requests and responses from ownership pre-fetch circuitry 260 to snoop filter 210. For example, arbitration circuitry 222 may arbitrate substantially equivalent access between upbound ordering FIFO queue 240 and read bypass FIFO queue 250 for transmission of transactions from a transaction queue upbound through the upbound path 220 to unordered interface 207.

Hub interface 280 may comprise one or more transaction queues such as upbound ordering FIFO queue 240 to maintain a transaction order for upbound transactions according to the ordering rules and to store the coherency state and source ID for each upbound transaction. The source ID may associate an agent, or I/O device, with a transaction. Further, upbound ordering FIFO queue 240 may maintain an ordering for transactions received from the same source agent, or same source ID and/or hub ID. For example, upbound ordering FIFO queue 240 may receive transactions from agent number one and transactions from agent number two. The transaction order(s) maintained for agent number one and agent number two may be independent unless the transactions are associated with the same memory line. As a result, transactions from agent number one may satisfy their corresponding ordering rules and be transmitted to the unordered interface 207 without regard to transactions from agent number two, while transactions from agent number two may remain in upbound ordering FIFO queue 240. In some embodiments, an upbound ordering FIFO queue, such as upbound ordering FIFO queue 240, may be dedicated for a particular hub ID or source ID.

Read bypass FIFO queue 250 may facilitate progress of read transactions, wherein a read transaction may be subject to ordering rules independent of or substantially independent of ordering rules associated with transactions in upbound ordering FIFO queue 240. Read bypass FIFO queue 250 may receive read transactions from both the I/O interface 290 and the upbound ordering FIFO queue 240. For instance, I/O interface 290 may receive a first read transaction that may be associated with an address that may not have a matching entry in address queue 275. As a result, the read transaction may be forwarded to the bottom of the read bypass FIFO queue 250. In alternate embodiments, hub interface 280 may comprise more than one read bypass FIFO queue to adjust access to upbound path 220 between targets of transactions or transactions from different sources.

An advantage of embodiments that may comprise transaction bypass circuitry, such as circuitry comprising read bypass FIFO queue 250, may be that transactions may be processed in less time than the nominal snoop latency of the system. For example, when a read transaction may bypass a write transaction for the same memory line(s), the latency of the read transaction may not be penalized by the latency of the write transaction. Further, in embodiments that comprise ownership pre-fetch circuitry, such as ownership pre-fetch circuitry 260, the latency of a write transaction may not be limited to the nominal snoop latency of the system so the latency of the write transaction may decrease to the latency for the embodiment to process to write transaction.

Ownership pre-fetch circuitry 260 may pre-fetch ownership of a memory line for a transaction received by I/O interface 290 to avoid some latency involved with requesting ownership of the memory after the transaction may satisfy its corresponding ordering rules. A determination to pre-fetch ownership may be based upon whether an ownership of the memory line may reside with a pending transaction in upbound ordering FIFO queue 240. For instance, I/O interface 290 may receive a write transaction to write data to memory line one. Address logic 270 may verify that no entry in the upbound ordering FIFO queue 240 may be associated with memory line one. In response, ownership pre-fetch circuitry 260 may request ownership of memory line one via snoop filter 210. After address logic 270 may determine that an entry in the upbound ordering FIFO queue 240 may be associated with memory line one, the write transaction may be placed into the bottom of upbound ordering FIFO queue 240 and ownership for memory line one by the write transaction may not be requested again until the write transaction may satisfy associated ordering rules or, in some embodiments, after the write transaction may reach or near the top of upbound ordering FIFO queue 240.

Address logic 270 may maintain address queue 275 comprising addresses associated with pending transactions in hub interface 280 and may compare an address of an upbound transaction against addresses in the queue to determine whether ownership may be pre-fetched for the upbound transaction. In embodiments wherein read cache and logic 285 may piggy-back or attach cache line invalidation data to read transactions to make a cache line available for a new copy of a memory line, read transactions may comprise more than one address so address logic 270 may compare more than one address associated with a read transaction against addresses stored in a queue to determine whether the read transaction should be forwarded to the read bypass FIFO queue 250 or to the upbound ordering FIFO queue 240.

Further, address queue 275 may comprise memory, or a queue, to store an invalidation address of cache line invalidation data. Address logic 270 and address queue 275 may maintain a list of one or more invalidation addresses to prevent a read transaction to read a memory line(s) from bypassing a transaction with cache line invalidation data, wherein the cache line invalidation data may be associated with the same memory line(s). Preventing a read transaction from bypassing the transaction with cache line invalidation data may enhance synchronization between snoop filter 210 and cache of read cache and logic 285.

In many embodiments, hub interface 280 may compare a read transaction to the list of invalidation addresses in address queue 275 before forwarding the read transaction to the snoop filter 210. In some embodiments, the read transaction may be held in a transaction queue, such as upbound ordering FIFO queue 240 or read bypass FIFO queue 250, until the cache line invalidation data may reach snoop filter 210. In several embodiments, the logic involved with checking invalidation addresses may be simplified by placing a read transaction with an address matching an address in a queue, such as a FIFO queue, of address queue 275 into the bottom of upbound ordering FIFO queue 240. The read transaction may be placed into the bottom of read bypass FIFO queue 250 when the address does not match an invalidation address in address queue 275 and/or be allowed to bypass upbound ordering FIFO queue 240 when read bypass FIFO queue 250 may be empty and the address does not match an invalidation address. In alternative embodiments, the snoop filter 210 may compare the read transaction against the list of addresses associated with cache line invalidation data pending in the transaction queue(s) and prevent the read transaction from being completed until the corresponding cache line invalidation data may reach snoop filter 210.

Read cache and logic 285 may snoop or monitor transactions as received by I/O interface 290. In some embodiments, read cache and logic 285 may comprise a queue to retrieve read transactions. Read cache and logic 285 may recognize a read transaction for a memory line and may determine when a copy of the memory line associated with the read transaction may be stored in read cache and logic 285. In response to a determination that a read transaction may be associated with a memory line that is not stored in read cache, read cache and logic 285 may attach a cache line invalidation, or cache line invalidation data, to the read transaction. The cache line invalidation may inform the snoop filter 210 of the invalidated cache line after the header for the read transaction may be received by snoop filter 210 and snoop filter 210 may modify a corresponding entry in a buffer of the snoop filter 210 to maintain cache coherency. Read cache and logic 285 may attach additional cache line invalidations to further read transactions to make room for copies of memory lines near the memory line associated with the read transaction.

In several embodiments, hub interface 280 may also provide circuitry to determine a coherency state for an inbound transaction and respond to coherency requests issued across coherency interface 230 from snoop filter 210. For example, when snoop filter 210 may send an ownership completion, hub interface 280 may accept the completion and update the status of the targeted inbound transaction as owning the memory line, or change the coherency state of the targeted inbound transaction from a pending state to ‘exclusive’. On the other hand, when snoop filter 210 may send an invalidation request targeting an inbound write transaction that has a coherency state of pending, e.g. may not own the memory line, hub interface 280 may accept the invalidation and reissue a request for ownership after the inbound write transaction may reach or near the top of upbound ordering FIFO queue 240.

After a transaction reaches the top of a transaction queue, such as upbound ordering FIFO queue 240 or read bypass FIFO queue 250, arbitration circuitry 222 may grant access to a transaction queue and the corresponding transaction may transmit to upbound path 220. Upbound path 220 may comprise pending data buffer 224 and pending transaction buffer 226. Pending data buffer 224 may receive and store data associated with upbound transaction awaiting transmission across unordered interface 207. Pending transaction buffer 226 may store a transaction header for a transaction pending on the unordered interface 207. For example, when I/O interface 290 may receive an upbound transaction, hub interface 280 may place the header of the transaction in upbound ordering FIFO queue 240 and transmit the data associated with the header to pending data buffer 224. At some point after satisfying ordering rules, the header may be forwarded to the pending transaction buffer 226 to await transmission across unordered interface 207. Then, the data may transmit across unordered interface 207.

In some embodiments, pending data buffer 224 may comprise a separate buffer for one or more I/O devices coupled with I/O interface 290 based upon one or more hub ID. In other embodiments, pending data buffer 224 may comprise mechanisms such as pointers to associate a section of a buffer with a hub ID.

In many embodiments, hub interface 280 may also comprise starvation circuitry to prevent starvation of a transaction, or leaf of transactions, as a result of ownership stealing. For example, starvation circuitry may monitor the number of invalidations transmitted to and/or accepted by hub interface 280 for a transaction, or a leaf of transactions, and once a count of invalidations reaches a starvation number, the starvation circuitry may stall the I/O interface 290 to flush the upbound ordering FIFO queue 240 and/or read bypass FIFO queue 250. The starvation number may be based upon statistical and/or heuristic data and/or a formula derived there from. Thus, the transactions associated with upbound ordering FIFO queue 240 and/or read bypass FIFO queue 250 may clear before additional write and/or read transactions may be received via I/O interface 290. In some embodiments, starvation circuitry may couple with arbitration circuitry 222 to modify the level of access arbitrated to upbound ordering FIFO queue 240 and/or read bypass FIFO queue 250.

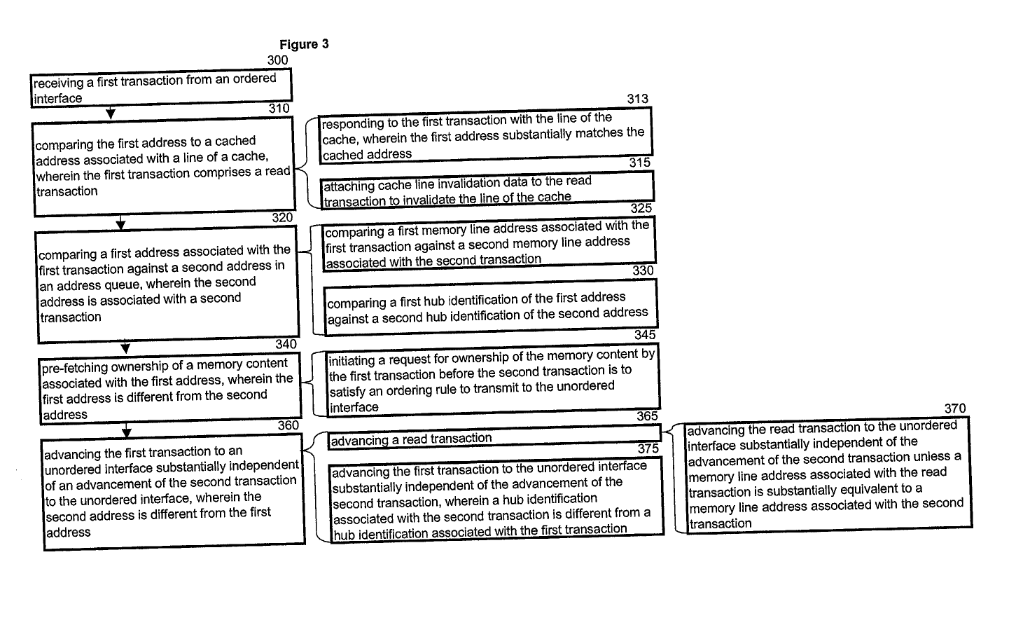

Referring now to FIG. 3, there is shown a flow chart of an embodiment to maintain ordering for transactions and to transact between an ordered interface and an unordered interface. The embodiment may comprise receiving a first transaction from an ordered interface 300; comparing the first address to a cached address associated with a line of a cache, wherein the first transaction comprises a read transaction 310; comparing a first address associated with the first transaction against a second address in an address queue, wherein the second address is associated with a second transaction 320; pre-fetching ownership of a memory content associated with the first address, wherein the first address is different from the second address 340; and advancing the first transaction to the unordered interface substantially independent of an advancement of the second transaction to the unordered interface, wherein the second address is different from the first address 360. Receiving a first transaction from an ordered interface 300 may comprise receiving a transaction from an I/O device coupled with the ordered interface in a transaction order according to ordering rules associated with the I/O interface or an I/O device coupled with the I/O interface. In many embodiments, the transactions may be received from more than one I/O device and, in several embodiments, the transactions received may comprise transactions subject to independent ordering rules.

Some embodiments may comprise comparing the first address to a cached address associated with a line of a cache, wherein the first transaction comprises a read transaction 310. Comparing the first address 310 may compare a first memory line address against memory line addresses in the cache to determine whether a valid copy of the memory line may be stored in a line of the cache. Comparing the first address 310 may comprise responding to the first transaction with the line of the cache, wherein the first address substantially matches the cached address 313 and attaching cache line invalidation data to the read transaction to invalidate the line in the cache 315. Responding to the first transaction with the line of the cache, wherein the first address substantially matches the cached address 313 may comprise retrieving a line of the cache from a cache to store data for a leaf and/or a hub ID. In other embodiments, the cache may comprise one or more memory arrays that dedicate an amount or physical division of the cache to store data for a leaf or hub ID. These embodiments may comprise populating the cache with data of a memory line anticipated to be the target of a subsequent read transaction. In many embodiments, a cache pre-fetch algorithm may anticipate a memory line as the target of a subsequent read transaction based upon a read and/or write transaction from an I/O device or leaf. Responding to the first transaction 313 may transmit a response or completion to the requester, or I/O device, without forwarding the read transaction to the unordered interface. In several of these embodiments, such a cache hit may reduce the latency of the read transaction, as well as transactions that may not compete with the read transaction for access to the unordered interface after the hit.

Attaching cache line invalidation data to the read transaction to invalidate the line in the cache 315 may, after a cache miss, attach data to cause the snoop filter to invalidate a line of the cache to make room for an additional entry in the cache. In some embodiments, the invalidation may be attached to or incorporated into a read transaction that may read a memory line to store in the cache and, in some embodiments, the memory line may be stored in the cache line associated with the invalidation. In one embodiment, the cache line invalidation data may be inserted into the header of the read transaction. In several embodiments, the cache line invalidation may be subject to an ordering rule that does not allow the cache line invalidation data to pass a transaction associated with the same memory line, e.g. the ordering of the invalidation is dependent upon the transaction order of another pending transaction. So the advancement of the read transaction toward the unordered interface may be restricted or limited by the ordering rule for the attached cache line invalidation. For example, the ordered interface may receive a read transaction and a comparison of the memory line associated with the read transaction may result in a cache miss. As a result, read cache logic may decide to store the memory contents of the memory line associated with the read transaction into the cache and piggy-back cache line invalidation data in the header of that read transaction. Address logic may determine the memory line subject to the read transaction may have a different address than addresses stored in the address queue, however, the address associated with the cache line invalidation data, or the invalidation address, may match an entry in the address queue. As a result, the read transaction may be placed at the bottom of an upbound ordering queue. Once the read transaction may reach the top of the upbound ordering queue, the read transaction may be eligible to transmit across the unordered interface, or may have satisfied the ordering rule corresponding to the cache line invalidation. In other situations, the read transaction may have to satisfy both an ordering rule associated with the invalidation address and the address of the memory line before becoming eligible to transmit upbound, advancing toward the unordered interface. After the snoop filter receives the cache line invalidation data, the snoop filter may invalidate an entry in the read cache to store the data resulting from the read transaction. After the completion for the read transaction is received, the data of the read completion may be written in the read cache at the entry associated with the cache line invalidation data.

Many embodiments may maintain a transaction order for an upbound transaction based upon an ordering of an I/O interface to transmit the upbound transaction to an unordered interface by placing the upbound transaction in an ordering queue. For example, a first write transaction received from an I/O interface may be placed in an upbound ordering queue. Then a second write transaction may be placed in the upbound order queue. After the first transaction may reach the top of the ordering queue, the first write transaction may issue to the unordered interface. In some embodiments, after receiving a completion for the first write transaction, the second write transaction may advance toward the unordered interface. In other embodiments, after the first write transaction may issue to the unordered interface, the second write transaction may advance upbound.

Many embodiments may maintain a transaction order to prevent problems associated with performing transactions out of order. For example, an agent on the ordered interface, such as an I/O device coupled with a bridge, may issue a series of four write transactions and, assuming that the transactions will be performed in order, issue a fourth write transaction that may modify the same memory contents that the first write transaction modifies. When these transactions may be performed in an order other than the order of issuance, the changes to the memory contents may be unpredictable.

Comparing a first address associated with the first transaction against a second address in an address queue, wherein the second address is associated with a second transaction 320 may determine whether a second transaction may perform an action upon the same memory line as the first transaction, whether the first and the second transaction may be issued from the same I/O device, or whether an invalidation address attached to the first transaction may match an address in the address queue. For instance, a write transaction and a read transaction may have been received prior to receiving the first transaction and the memory line addresses associated with the write and read transactions may be stored in an address queue. After the first transaction is received, the address logic circuitry may compare the memory line address associated with the first transaction against the memory line addresses associated with the read and write transactions to determine that one, both, or neither of the transactions may perform an action on the same memory line. In response to a determination that one of or both the read and write transaction may perform an action on the same address, the address logic may transmit a signal to the ownership pre-fetch circuitry. In many of these embodiments, a signal may be transmitted to the ownership pre-fetch circuitry to stop, request, and/or initiate, pre-fetching ownership for the first transaction.

Comparing a first address associated with the first transaction against a second address in an address queue, wherein the second address is associated with a second transaction 320 may comprise comparing a first memory line address associated with the first transaction against a second memory line address associated with the second transaction 325 and comparing a first hub identification of the first address against a second hub identification of the second address 330. Comparing a first memory line address 325 may compare the address of the memory line that the first transaction may perform a read of or write to against the address of the memory line address that the second transaction may perform a read of or write to, to determine whether the first transaction and the second transaction may perform action on the same memory line and, in many embodiments, whether the transactions may perform actions on the same memory contents of the memory line. For example, when the first transaction is a write and the second transaction is a write transaction, comparing a first memory line address 325 may determine that the first transaction may write to the same memory cells as the second transaction. In other situations, comparing a first memory line address 325 may determine that a read may be performed on the same memory cells as a write. In many embodiments, comparing a first memory line address 325 may further determine whether the first transaction may advance toward the unordered interface, or upbound, independent of an advancement of the second transaction upbound by comparing an invalidation address associated with the first transaction against a list of invalidations addresses in an address queue.

Comparing a first hub identification of the first address against a second hub identification of the second address 330 may determine whether the first transaction and the second transaction are transactions from the same I/O device, such as an Ethernet card. For example, two I/O devices may be coupled to a bridge and the bridge may be coupled with an I/O interface to allow the two input output devices to transact across an unordered domain. The first I/O device may be associated with a hub ID of zero and the second I/O device may be associated with a hub ID of one. When the buses interconnecting the two I/O devices to the I/O interface is a peripheral component interconnect bus and operate according to PCI ordering rules, the transactions associated with the first I/O device (hub ID zero) may be independent of transactions associated with the second I/O device (hub ID one) with respect to ordering rules. Some embodiments take advantage of the independence by comparing a first hub identification of the first address against a second hub identification of the second address 330. Other embodiments may not track the hub ID associated with a transaction.

Referring still to FIG. 3, pre-fetching ownership of a memory content associated with the first address, wherein the first address is different from the second address 340 may initiate a request for ownership of an address prior to the first transaction satisfying ordering rules associated with that first transaction. Pre-fetching ownership 340 may pre-fetch ownership of the memory content for a transaction so that the transaction may be ready to transmit across an unordered domain as soon as the transaction satisfies its ordering requirements.

Pre-fetching ownership 340 may comprise initiating a request for ownership of the memory content by the first transaction before the second transaction is to satisfy an ordering rule to transmit to the unordered interface 345. Initiating a request for ownership 345 may steal an ownership from the second transaction, or take ownership of the same memory line as the second transaction, wherein the transaction order of the first transaction is independent of the ordering rules associated with the second transaction. After the ownership of the same memory line is taken by the first transaction, or stolen, the snoop filter may invalidate the ownership of the memory line by the second transaction. In other situations, the second transaction may not have an ownership of the memory line so the first transaction may gain ownership of the memory line before the second transaction may receive ownership. In many of these cases, the first transaction and the second transaction may race to satisfy ordering rules and after the second transaction may satisfy its ordering rules first, the second transaction may steal the ownership from the first transaction. In other situations, after the first transaction may transmit across the unordered domain and/or a completion may be received for the first transaction, the second transaction may request and receive ownership for the memory line.

In some embodiments, initiating a request for ownership of the memory content by the first transaction 345 may pre-fetch ownership for the first transaction after a determination that the ordering requirements of, or ordering rules for, the first transaction may be independent of the ordering rules for the second transaction. In many embodiments, determining the ordering rules may be independent may comprise determining that the first address and the second address are different, such as a different target address or a different source address. The difference target address may comprise a different memory line and the different source address may comprise a different hub ID. The hub ID may be a part of a number that identifies the source I/O device.

Many embodiments may comprise advancing the first transaction to an unordered interface substantially independent of an advancement of the second transaction to the unordered interface, wherein the second address is different from the first address 360 may allow a read or write transaction to bypass the upbound ordering queue wherein the memory line associated with the read or write transaction, invalidation address, and/or the hub ID associated with the read or write transaction may differ from memory lines, invalidation addresses, and/or hub ID's stored in the address queue.

Advancing the first transaction to an unordered interface substantially independent of an advancement of the second transaction to the unordered interface, wherein the second address is different from the first address 360 may comprise advancing a read transaction 365 and advancing the first transaction to the unordered interface substantially independent of the advancement of the second transaction, wherein a hub identification associated with the second transaction is different from a hub identification associated with the first transaction 375. Advancing a read transaction 365 may place the read transaction in a read bypass queue when the read transaction was initiated by a source device associated with a hub ID that is different from hub ID's associated with transactions in an upbound ordering queue. For instance, a read transaction having a hub ID of zero may be placed in the read bypass queue wherein transactions in the upbound ordering queue associated with hub ID zero have no entries associated with hub ID zero.

Advancing a read transaction 365 may comprise advancing the read transaction to the unordered interface substantially independent of the advancement of the second transaction unless a memory line address associated with the read transaction is substantially equivalent to a memory line address associated with the second transaction 370. Advancing the read transaction 370 may forward the read transaction to a read bypass queue when the memory line to be read is different from the memory lines stored in the address queue or memory lines of transactions awaiting transmission across the unordered interface. In embodiments where the address queue may also store hub ID's associated with pending transactions, advancing the read transaction 370 may also forward the read transaction to the read bypass queue when the hub ID associated with the read transaction is different from the hub ID's in the address queue.

Advancing the first transaction to the unordered interface substantially independent of the advancement of the second transaction, wherein a hub identification associated with the second transaction is different from a hub identification associated with the first transaction 375 may allow a write and/or read transaction to bypass another write or read transaction in an upbound ordering queue since the ordering for the transactions are independent. For example, a write transaction initiated by a first I/O device may write to memory line one of a system memory in an unordered domain via an unordered interface. A read transaction may read from memory line one and may be initiated by a second I/O device after the write transaction was stored in the upbound ordering queue. However, after comparing the address of the read transaction again the address of the write transaction, the read transaction may bypass the write transaction since the ordering rules associated with the read transaction are independent of the ordering rules associated with the write transaction.

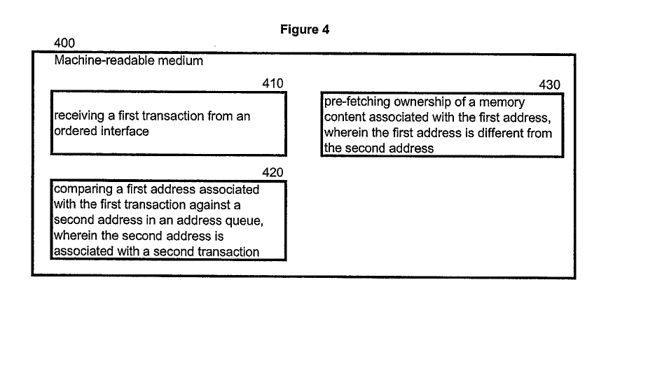

Referring now to FIG. 4, a machine-readable medium embodiment of the present invention is shown. A machine-readable medium includes any mechanism that provides (i.e. stores and or transmits) information in a form readable by a machine (e.g., a computer), that when executed by the machine, may perform the functions described herein. For example, a machine-readable medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc. . . . Several embodiments of the present invention may comprise more than one machine-readable medium depending on the design of the machine.

In particular, FIG. 4 shows an embodiment of a machine-readable medium 400 comprising instructions for receiving a first transaction from an ordered interface 410; comparing a first address associated with the first transaction against a second address in an address queue, wherein the second address is associated with a second transaction 420; and pre-fetching ownership of a memory content associated with the first address, wherein the first address is different from the second address 430. Receiving a first transaction from an ordered interface 410 may comprise receiving a read or write transaction from an I/O device coupled with the ordered interface to transmit across an unordered interface.

Instructions for comparing a first address associated with the first transaction against a second address in an address queue, wherein the second address is associated with a second transaction 420 may comprise instructions for comparing an address associated with a write transaction against one or more addresses stored in an address queue to determine whether a pending transaction in an upbound ordering queue or pending on the unordered interface may be associated with the same or substantially the same address. For example, a transaction, after having satisfied ordering rules, may be pending on an unordered interface. A subsequent transaction may be received and the address associated with the transaction may match or substantially the address of the transaction pending on the unordered interface. As a result, instructions may prevent the subsequent transaction from obtaining ownership of the memory line, wherein the subsequent transaction may comprise a write transaction. On the other hand, when the instruction may cause the subsequent transaction to be forwarded to an upbound ordering queue wherein the subsequent transaction comprises a read transaction.

Instructions for pre-fetching ownership of a memory content associated with the first address, wherein the first address is different from the second address 430 may comprise instructions for pre-fetching ownership for a write transaction wherein the address, such as a memory line address and/or hub ID, associated with the write transaction is different from one or more addresses stored in an address queue. The instructions to determine the address is different from one or more addresses stored in an address queue may comprise instructions to determine whether the write transaction is subject to ordering rules that are not independent of ordering rules of transactions awaiting transmission across the unordered interface.

What is claimed is:

1. An apparatus, comprising:
an input-output interface to receive a first transaction associated with a first address;
an address queue coupled with said input-output interface to store a second address of a pending transaction;
address logic circuitry coupled with said address queue to compare the first address against the second address; and
ownership pre-fetch circuitry coupled with said address logic circuitry to initiate a request for an ownership of a first memory content associated with the first address for the first transaction unless the first address is substantially equivalent to the second address.

2. The apparatus of claim 1, further comprising a transaction queue coupled with said input-output interface to store a header for the pending transaction.

3. The apparatus of claim 1, further comprising a cache coupled with said input-output interface to store data of a memory line to anticipate a subsequent read transaction.

4. The apparatus of claim 3, further comprising read logic circuitry coupled with said input-output interface to attach cache line invalidation data to another read transaction to invalidate the read data.

5. The apparatus of claim 1, further comprising transaction bypass circuitry coupled with said input-output interface to allow the first transaction to advance upbound substantially independent of an advancement of the pending transaction, wherein the first address is different from the second address.

6. The apparatus of claim 5, wherein the transaction bypass circuitry comprises transaction bypass circuitry coupled with said input-output interface to the first transaction to advance upbound substantially independent of an advancement of the pending transaction, wherein a memory line address associated with the first transaction is different from a memory line address associated with the pending transaction.

7. The apparatus of claim 5, wherein the transaction bypass circuitry comprises transaction bypass circuitry coupled with said input-output interface to allow the first transaction to advance upbound substantially independent of an advancement of the pending transaction, wherein a first hub identification associated with the first transaction is different from a second hub identification associated with the pending transaction.

8. The apparatus of claim 1, wherein said input-output interface comprises circuitry to transmit and receive data from an input-output device.

9. The apparatus of claim 1, wherein said address queue comprises circuitry to associate the second address with the pending transaction.

10. The apparatus of claim 9, wherein the circuitry comprises memory to store an association with an entry in a transaction queue.

11. The apparatus of claim 1, wherein said address logic circuitry comprises circuitry to compare the first address against an invalidation address associated with the pending transaction to prevent the first transaction from bypassing the pending transaction, wherein the invalidation address is substantially equivalent to the first address.

12. The apparatus of claim 1, wherein said ownership pre-fetch circuitry comprises circuitry to initiate the request for the ownership before a transaction order of the first transaction is to satisfy an ordering rule.

13. A method, comprising:
receiving a first transaction from an ordered interface;
comparing a first address associated with the first transaction against a second address in an address queue, wherein the second address is associated with a second transaction; and
pre-fetching ownership of a memory content associated with the first address, wherein the first address is different from the second address.

14. The method of claim 13, further comprising comparing the first address to a cached address associated with a line of a cache, wherein the first transaction comprises a read transaction.

15. The method of claim 14, further comprising responding to the first transaction with the line of the cache, wherein the first address substantially matches the cached address.

16. The method of claim 14, further comprising attaching cache line invalidation data to the read transaction to invalidate the line of the cache.

17. The method of claim 13, further comprising advancing the first transaction to an unordered interface substantially independent of an advancement of the second transaction to the unordered interface, wherein the first address is different from the second address.

18. The method of claim 17, wherein advancing the first transaction comprises advancing a read transaction.

19. The method of claim 18, wherein advancing the first transaction comprises advancing a read transaction to the unordered interface substantially independent of the advancement of the second transaction unless a memory line address associated with the read transaction is substantially equivalent to a memory line address associated with the second transaction.

20. The method of claim 17, wherein advancing the first transaction comprises advancing the first transaction to the unordered interface substantially independent of the advancement of the second transaction, wherein a hub identification associated with the second transaction is different from a hub identification associated with the first transaction.

21. The method of claim 13, wherein said comparing a first address comprises comparing a first memory line address associated with the first transaction against a second memory line address associated with the second transaction.

22. The method of claim 13, wherein said comparing a first address comprises comparing a first hub identification of the first address against a second hub identification of the second address.

23. The method of claim 13, wherein said pre-fetching ownership comprises initiating a request for ownership of the memory content by the first transaction before the second transaction is to satisfy an ordering rule to transmit to the unordered interface.

24. A system, comprising:
an input-output interface to receive a first transaction associated with a first address;
an address queue coupled with said input-output interface to store a second address of a pending transaction;
address logic circuitry coupled with said address queue to compare the first address against the second address;
ownership pre-fetch circuitry coupled with said address logic circuitry to initiate a request for an ownership of a first memory content associated with the first address for the first transaction, wherein the first address is different from the second address;
a transaction queue coupled with said input-output interface to maintain a transaction order for the pending transaction; and
a memory device coupled with said transaction queue to respond to the pending transaction.

25. The system of claim 24, further comprising a scalability port switch coupled with said transaction queue to transmit the pending transaction to said memory device.

26. The system of claim 24, further comprising a bridge coupled with said input-output interface to couple more than one input-output device with said input-output interface.

27. A machine-readable medium containing instructions, which when executed by a machine, cause said machine to perform operations, comprising:
receiving a first transaction from an ordered interface;
comparing a first address associated with the first transaction against a second address in an address queue, wherein the second address is associated with a second transaction; and
pre-fetching ownership of a memory content associated with the first address, wherein the first address is different from the second address.

28. The machine-readable medium of claim 27, further comprising comparing the first address to a cached address associated with a line of a cache, wherein the first transaction comprises a read transaction.

29. The machine-readable medium of claim 27, wherein said comparing a first address comprises comparing a first hub identification of the first address against a second hub identification of the second address.

30. The machine-readable medium of claim 27, wherein said pre-fetching ownership comprises initiating a request for ownership of the memory content by the first transaction.
